(19) United States
(12) Patent Application Publication
(10) Pub. No.: US 2004/0054732 A1
(43) Pub. Date: Mar. 18, 2004

(54) Apparatus, system and method of sending e-mail messages using physical locations as e-mail addresses

(75) Inventors: William Stephen Carter, Round Rock, TX (US); Herman Rodriguez, Austin, TX (US); Hypatia Rojas, Round Rock, TX (US); Newton James Smith JR., Austin, TX (US)

Correspondence Address: MR. Volel Emile, P.O. Box 202170, Austin, TX, 78720-2170, US

(73) Assignee: International Business Machines Corporation, Armonk, NY

(21) Appl. No.: 10/242,491

(22) Filed: Sep. 12, 2002

(51) Int. Cl. G06F 15/16

(52) U.S. Cl. 709/206

(57) ABSTRACT

An alternative method, system and apparatus for addressing an e-mail message are provided. The alternative method, system and apparatus include using a physical location to address the e-mail message. The physical location may be a street address; however, whether a physical location or a street address is used, Global Positioning System (GPS) coordinates are used to forward the message to its destination. The message may include a range outside of which it is not retrievable. The message may further include a maximum number of recipients that may retrieve it as well as a time span outside of which it is not retrievable.

### CROSS-REFERENCE TO RELATED APPLICATIONS

This application is related to co-pending U.S. patent application Ser. No. ______ (IBM Docket No. AUS920020495), entitled APPARATUS, SYSTEM AND METHOD OF DELIVERING E-MAIL MESSAGES herein, filed on even date herewith and assigned to the common assignee of this application.

This application is also related to co-pending U.S. patent application Ser. No. ______ (IBM Docket No. AUS920020496), entitled APPARATUS, SYSTEM AND METHOD OF RECEIVING E-MAIL MESSAGES SENT TO PHYSICAL LOCATIONS herein, filed on even date herewith and assigned to the common assignee of this application.

### BACKGROUND OF THE INVENTION

1. Technical Field

The present invention is directed to a method and apparatus for managing electronic mail. More specifically, the present invention is directed to an apparatus, system and method of sending e-mail messages using physical locations as addresses.

2. Description of Related Art

Electronic mail or e-mail is the transmission of messages over communications networks. Most e-mail systems include a rudimentary text editor for composing messages, but many also allow a user to compose messages using any text editor. After composing a message, the message is sent to a recipient by specifying the recipient's e-mail address (e.g., xyz@us.ibm.com) in an address box. Thus, one of the requirements for sending e-mail messages is that the e-mail addresses of the recipients be known.

Sometimes, however, an e-mail sender may know a physical location where a recipient may be but not necessarily know the recipient's actual e-mail address. In such cases, it would be desirable to have an alternate method available to send an e-mail message to a recipient.

Consequently, what is needed is an apparatus, system and method of using an alternate manner of sending e-mail messages to recipients.

### SUMMARY OF THE INVENTION

The present invention provides an alternative method, system and apparatus for addressing an e-mail message. The alternative method, system and apparatus include using a physical location to address the e-mail message. The physical location may be a street address; however, whether a physical location or a street address is used, Global Positioning System (GPS) coordinates are used to forward the message to its destination. The message may include a range outside of which it is not retrievable. The message may further include a maximum number of recipients that may retrieve it as well as a time span outside of which it is not retrievable.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4(a) is a graphical user interface (GUI) of an existing e-mail software tool.

FIG. 4(b) is a GUI of an e-mail software tool that may be used by the present invention.

FIG. 4(c) depicts FIG. 4(b) with a pop-up window into which an e-mail sender may enter a time span within which a message may be retrieved.

FIG. 4(d) illustrates FIG. 4(b) with a pop-up window into which an e-mail sender may enter a maximum distance a recipient may be from a physical location and still be able to retrieve a message.

FIG. 4(e) depicts FIG. 4(b) with a pop-up window into which a sender may specify a number of recipients who may retrieve a location-based e-mail message.

FIG. 5(a) depicts a recipient within a distance from a location to which an e-mail message has been sent.

FIG. 5(b) depicts a physical location to which an e-mail message has been sent.

FIG. 6 is a flow chart of a process that may be used by an e-mail software tool to send an e-mail message to a recipient.

FIG. 7 is a flow chart of a process that may be used by an e-mail software tool of an ISP (Internet Service Provider) for implementing the invention.

FIG. 8 is a flow chart of a process that may be used by an e-mail software tool of an ISP serving a recipient.

FIG. 9 is a flow chart of a process that may be used by an e-mail software tool of a clearinghouse.

### DETAILED DESCRIPTION OF THE PREFERRED EMBODIMENT

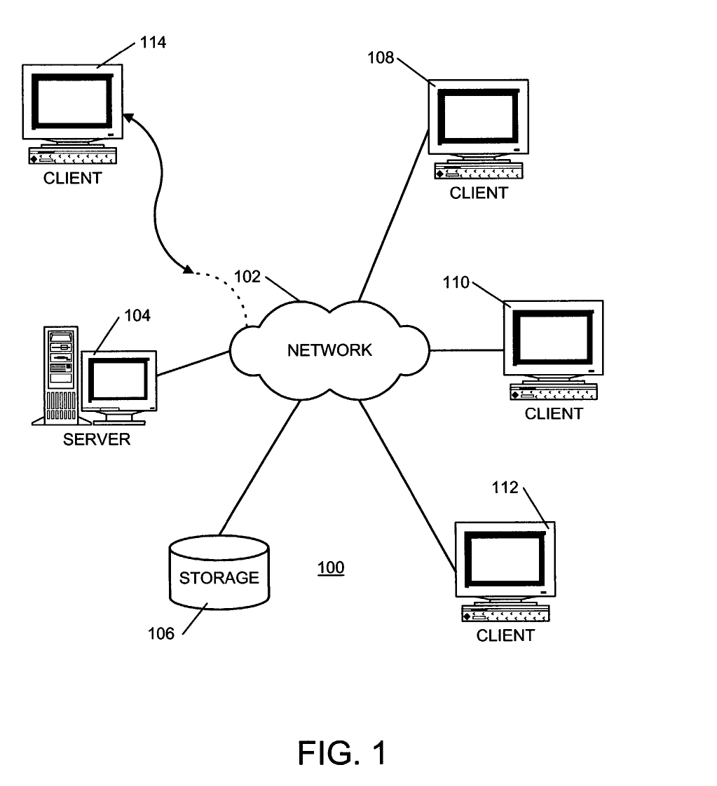

Turning to the figures, wherein like numbers denote like parts throughout, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, 112 and 114 are connected to network 102. These clients 108, 110 and 112 may be, for example, personal computers or network computers. Client 114 may be a cellular phone with an integrated browser to access the network or any wireless data communications system. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

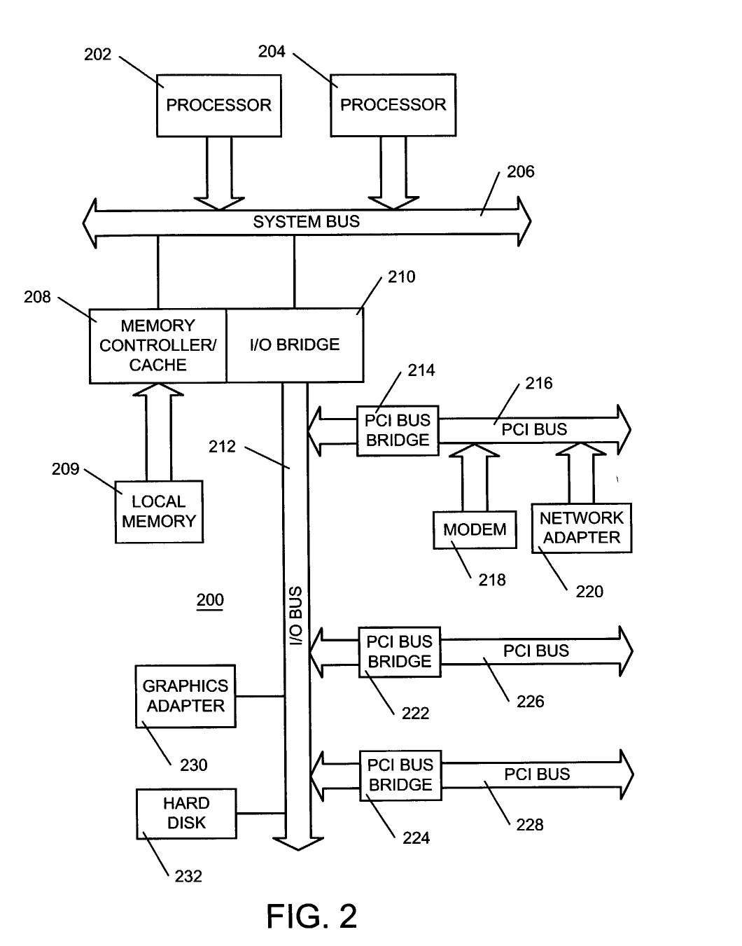

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

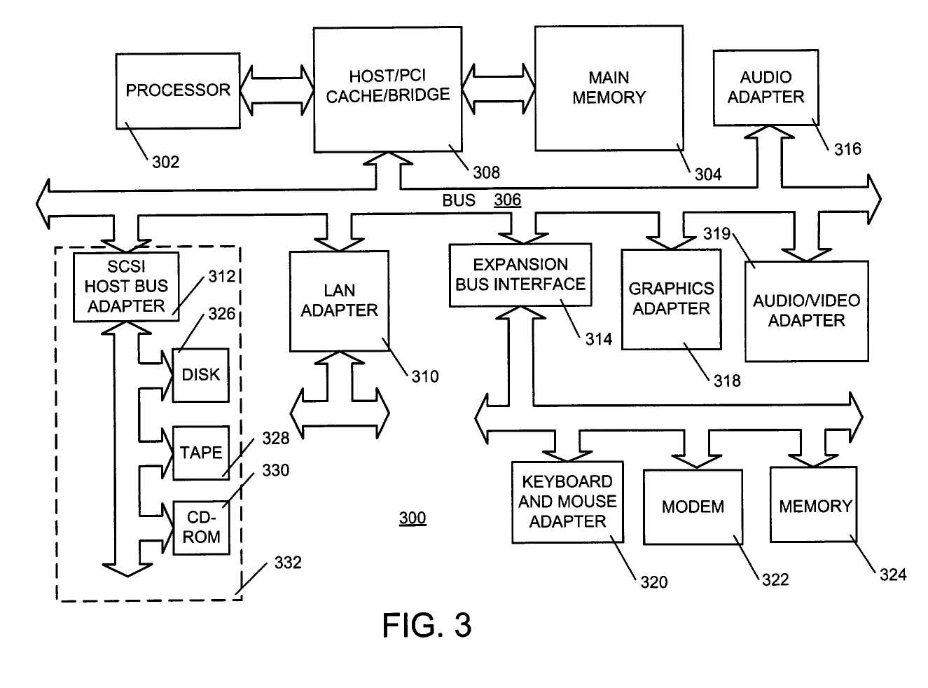

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an alternative apparatus, system and method of addressing e-mail messages. The alternative apparatus, system and method are based on user locations rather than e-mail addresses when addressing messages. The invention may be local to client systems 108, 110, 112 and 114 of FIG. 1 or to the server 104 or to both the server 104 and clients 108, 110, 112 and 114. Also, the present invention may reside on any data storage medium (i.e., floppy disk, compact disk, hard disk, ROM, RAM, etc.) used by a data communications system.

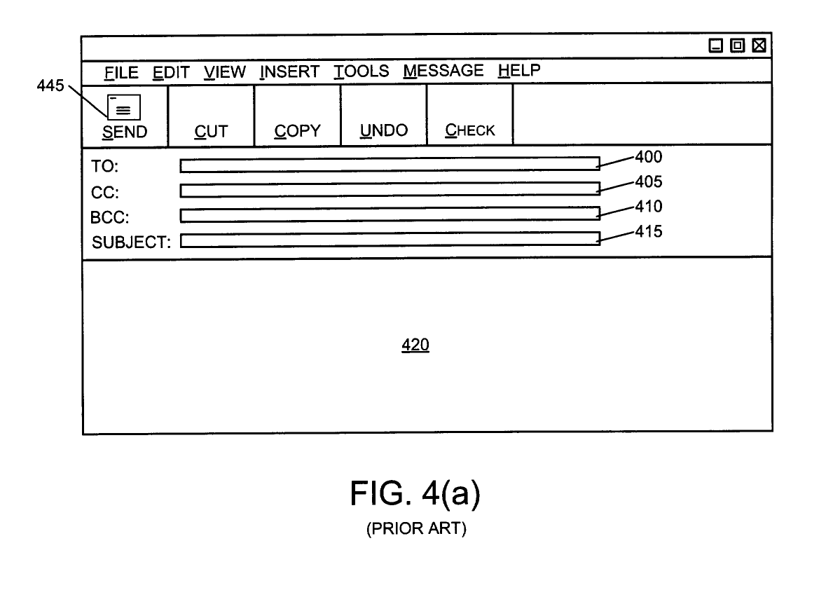

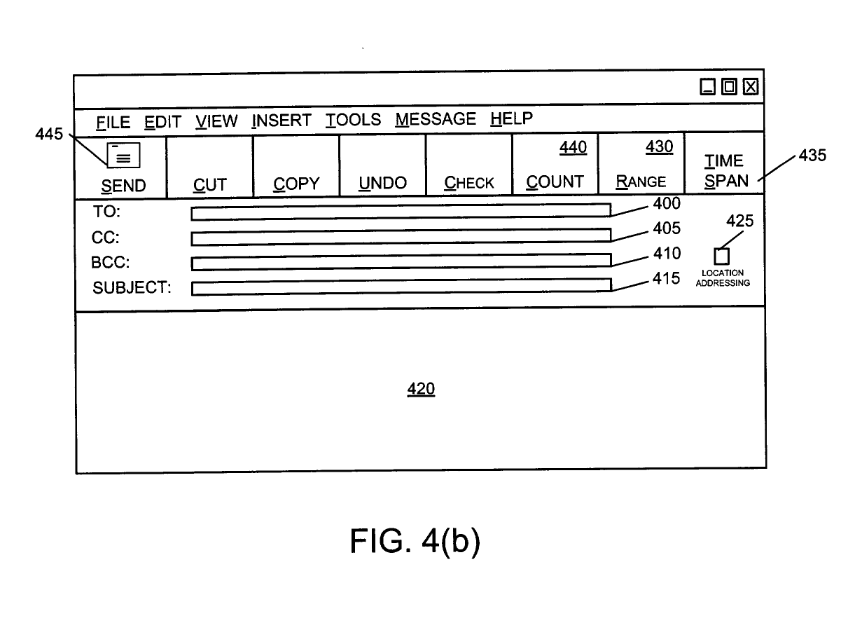

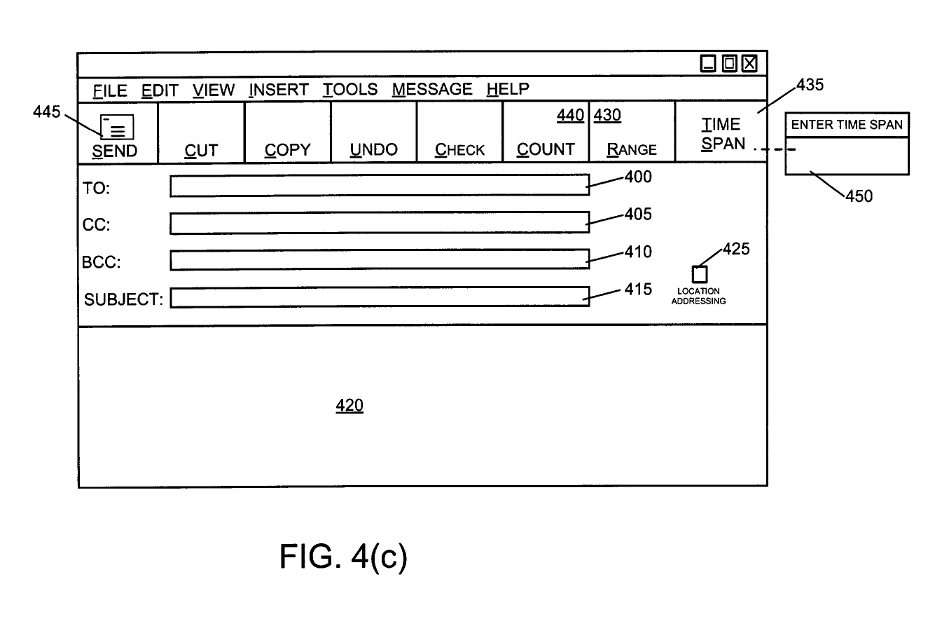

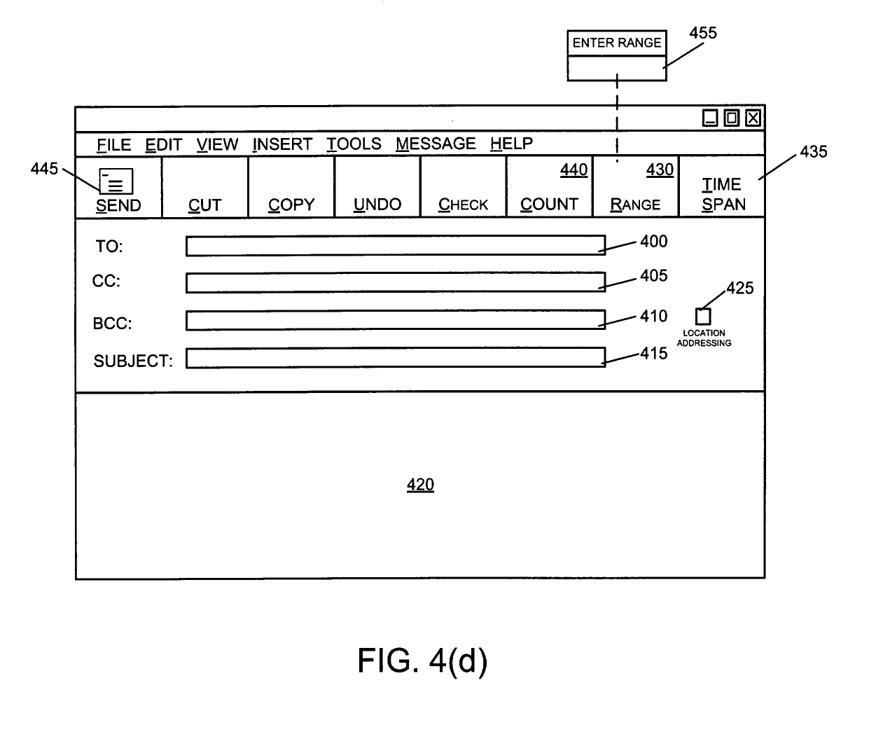

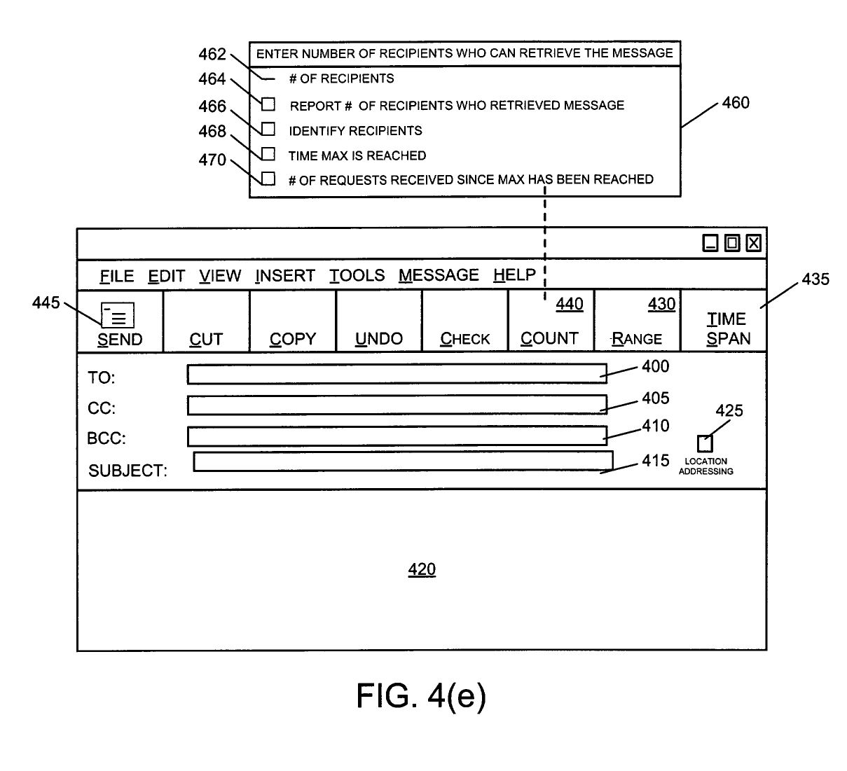

FIG. 4(a) is a graphical user interface (GUI) of an existing e-mail composing software tool. In this figure, only the items that are of importance to the invention are given a reference number. The GUI has address box 400, carbon copy box 405, blind copy box 410, subject matter box 415 and message or text area 420. E-mail addresses of intended recipients are entered into address box 400. Carbon copy box 405 is used to enter the e-mail addresses of recipients who the sender intends to be aware of the content of the message; but, the message is not necessarily addressed to them. Blind copy box 410 is used to enter the e-mail addresses of recipients that the user wishes to know about the content of the message, but as with the recipients in address box 405, the message is not addressed to them. Recipients whose e-mail addresses are entered in address box 400 and carbon copy box 405 are aware that they all receive the message. However, they are not aware that the recipients whose e-mail addresses are entered in blind copy box 410 receive the message also. But, the recipients whose e-mail addresses are entered in blind copy box 410 are aware that all other recipients do receive the message. The subject matter of the message is entered in subject box 415 and the actual message is entered in text area 420.

FIG. 4(b) is a GUI of an e-mail software tool that may be used by the present invention. Except for location addressing box 425, range 430, time span 435 and count 440, this GUI is identical to the GUI depicted in FIG. 4(a). The location addressing box 425 enables a user to send e-mail messages to a recipient using the recipient's physical location or street address. A physical location may be characterized by a set of Global Positioning System (GPS) coordinates. GPS is a space-based radio positioning system that provides a 24-hour three-dimensional position to suitably equipped users anywhere on or near the surface of the Earth. The three-dimensional position includes latitudinal, longitudinal and altitudinal positions.

When the box 425 is checked, a user may use e-mail addresses, street addresses, physical locations or a combination thereof to direct e-mail messages to recipients. If a street address is used, it is converted to a corresponding physical location (e.g., GPS coordinates) before the e-mail message is sent to the recipient for whom the street address is used. The conversion may occur on the sender's machine (i.e., before the e-mail message is sent to the server of the sender's Internet Service Provider or ISP) or it may occur on the ISP's server. Whichever machine converts the street address to its corresponding physical location has to have a software tool or equivalent to do so. The software tool may include a geographical map on which street addresses may be transposed in order to obtain corresponding physical locations. Alternatively, the software tool may include a table cross-referencing each street address to its corresponding physical location.

The sender may specify how long an unread message may remain in a recipient's inbox before it is deleted or when the message can be retrieved by clicking on time span button 435. When this is done, the sender may be prompted to enter a length of time. The length of time may be entered in any format (e.g., 15 days, one year, from Aug. 1, 2002 to Sep. 1, 2002 or on Jul. 4, 2002 between 2 PM and 4 PM etc.).

FIG. 4(c) depicts FIG. 4(b) with a pop-up window 450 into which the sender may enter the time span. Note that this feature may be applied to recipients who are addressed using regular e-mail addresses as well as recipients who are addressed using either street addresses and/or physical locations.

In cases where a physical location and/or a street address is used, the sender may specify how far away from the location a recipient may be in order to retrieve the message. To do so, the sender needs to click on range button 430. When range 430 is asserted, the sender may be prompted to enter a range (e.g., 30 yards, a mile etc.). FIG. 4(d) illustrates FIG. 4(b) with a pop-window 455 into which the sender may enter the maximum distance a recipient may be from a physical location and still be able to retrieve the message.

Count button 440 is used to limit the number of recipients who may retrieve a location-based e-mail message. As in the above cases, when count button 440 is asserted, the sender may be prompted to enter the maximum number of recipients who may retrieve the e-mail message. Once that number is reached, the message may become irretrievable. This is ideal for advertisements and product promotions. For example, this can be used in cases where recipients are invited to an event with a limited seating arrangement or where a limited number of recipients is to receive a discount on an admission fee or on the price of a product etc.

Further, when this option is set, the sender may request that certain delivery results be returned. For instance, the sender may specify that a notification as to whether the e-mail message was retrieved by anyone at all be returned. The sender may also want to know who has retrieved the message, whether the maximum number of recipients who could retrieve the message has retrieved it when the last recipient retrieved it, the telephone numbers of those who retrieved the message, how many requests were received after the maximum number was reached, the e-mail addresses of the recipients who retrieved the message etc.

FIG. 4(e) depicts FIG. 4(b) with a pop-up window 460 into which a sender may specify the number of recipients who may retrieve a location-based e-mail message. For instance, number of recipients 462 indicates where the sender may enter the maximum number of recipients who may retrieve the message. When box 464 is checked, a report regarding the number of recipients who have actually retrieved the message will be sent back to the sender. If the sender wants to know the identity of the recipients (e.g., name, domain-based e-mail address, phone number etc.) who retrieved the message, the sender may check box 466. A checked box 468 indicates that the sender wants to be made aware of the time the last recipient retrieved the message. All these reports may be sent to the sender after the maximum count is reached, a time span has elapsed or upon request.

Instead of directly entering a physical location or a street address to send a message to a recipient, a user may use a geographical map of an area and select a particular location from the map to which the e-mail message is to be sent. FIG. 10 depicts a geographical map from MAPQUEST that the user may have downloaded. If the user, using a pointing device such as a mouse, selects location 1005, the geographical or GPS coordinates of that location may be used to address the message. Note that throughout the present disclosure, geographical coordinates are used to denote longitudinal and latitudinal positions of a location whereas GPS coordinates are used to denote latitudinal, longitudinal and altitudinal positions of a location.

As alluded to above, when the sender asserts the send button 445, the e-mail message is transmitted to the server of the sender's ISP. There, address boxes 400, 405 and 410 are scrutinized to determine where the message is to be sent. According to the present invention, when the ISP's server receives the e-mail message, it will make a determination as to whether location addressing button 425 is checked. A bit can be used to so indicate. In this case, the bit may be set when button 425 is checked and unset otherwise.

Recipients who are addressed using either a physical location or a street address may receive their e-mail message from the sender's ISP if they have the same ISP as the sender. This could be a feature that ISPs, such as AOL, may provide to their customers. Recipients who are so addressed but do not have the same ISP as the sender may receive their location-based e-mail messages under one of two different schemes. First, the recipients may have a list of different ISPs that support the location-based e-mail addressing system. In that case, the recipients may query these ISPs to determine whether there is any message that has been physically addressed to their location in storage.

Second, one or more clearinghouses for location-based e-mail messages may be used. All ISPs that support the location-based e-mail addressing system may register with the clearinghouses. When a sender's ISP receives a location-based e-mail addressing message, it may send the message to the clearinghouses for storage. When a recipient wants to find out whether there are any e-mail messages addressed to the location, the recipient's ISP may be contacted. The recipient's ISP may then query the clearinghouses directly for the e-mail message. Note that in this case, the recipient's ISP need not have location-based e-mail addressing capability since it needs only connect the recipient to one or all of the clearinghouses for the recipient to retrieve the e-mail message. If a message is found, the recipient's ISP may retrieve it from one of the clearinghouses and forward it to the recipient.

Alternatively, a recipient may contact the clearinghouses directly. Upon receipt of a request from a recipient, the clearinghouses may query all registered ISPs for e-mail messages sent to a particular location. If there are any, the clearinghouses may retrieve and forward the messages to the recipients. Or, a registered ISP that has the requested messages may send the messages directly to the requesting recipient. In this case, the clearinghouses need not store the messages.

Another alternative is for the clearinghouses to periodically query registered ISPs for location-based e-mail addressing messages. If one is found, the clearinghouses may keep a pointer pointing to its location. When a recipient queries a clearinghouse for a location-based e-mail addressing message, the clearinghouse may retrieve and forward the message to the recipient. Or, as before, the registered ISP that has the requested message may forward the message directly to the recipient. Again, the clearinghouses need not store the message.

Note that in cases where the recipients directly query the clearinghouses, this may be facilitated by the recipients' ISPs. That is, a recipient's ISP may connect the recipient to the clearinghouses. This may be a service offered by the ISPs for a fee. The fee may be collected from e-mail senders (in cases of store advertisements) or from the recipients (in cases where recipients want to allow e-mail senders to send them messages using their street addresses and/or physical locations). In any event, the connection may be transparent to the recipient.

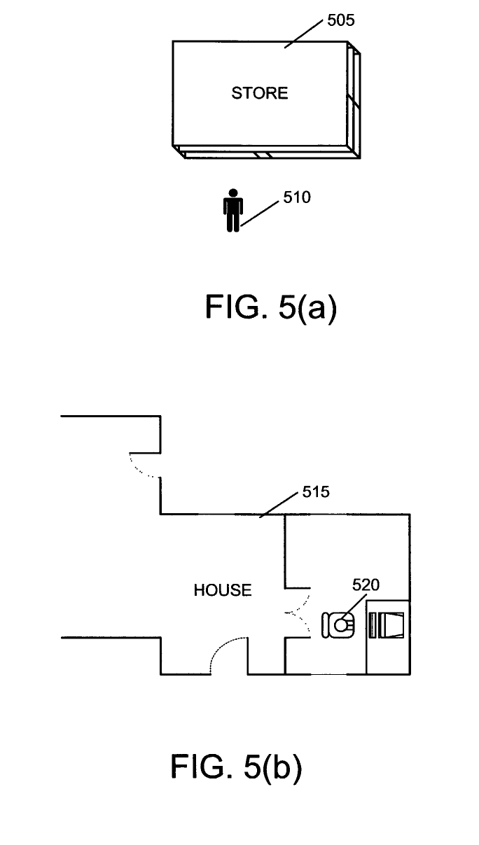

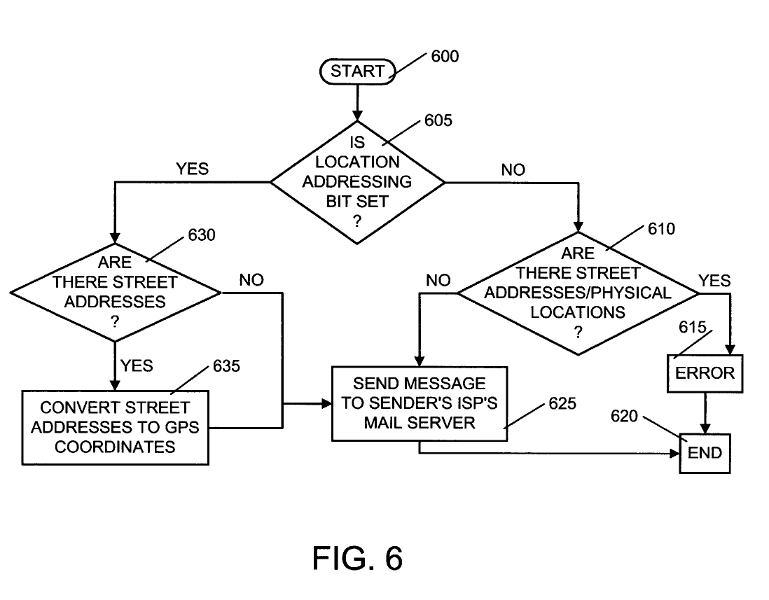

As can be surmised from the description above, in order for a recipient to retrieve a location-based e-mail addressing message, the recipient may have to be within a certain distance from the addressed physical location. FIG. 5(a) depicts a recipient within a distance from a location to which an e-mail message has been sent. In this figure, the addressed location is a store 505. A recipient 510, who may be a customer of the store 505, may be in the parking lot of the store or in a location that is within the maximum distance entered in FIG. 4(d). If the customer 510 has a cellular phone (not shown) or a personal organizer (not shown), such as a palm computer with data communications capability, the customer 510 may retrieve the messages. The messages may be information on items that are on sale or being discounted, coupons etc. The sender of the messages may be an employee of the store.

To ascertain that the customer is indeed within the distance entered in FIG. 4(d), the equipment that the customer is using to retrieve the message (e.g., the cell phone or Palm computer etc.) may have to have an embedded GPS receiver. A GPS receiver receives signals from three different GPS satellites to compute its own longitudinal, latitudinal and altitudinal position. Once the position or the location of the GPS receiver is computed, it may then be passed to the clearinghouses along with the customer's request for messages. If there are messages sent to the physical location and the customer is within the range specified, the messages are then forwarded to the customer.

FIG. 5(b) depicts another physical location 515 to which an e-mail message has been sent. In this case, the physical location 515 is a house. Recipient 520 may retrieve the message using a home computer or equivalent device. If the home computer uses a land-based connection (i.e., a dial-up connection, DSL, cable etc.), recipient's ISP may vouch for the recipient's physical location being the address to which the message is sent. In that case, a GPS receiver is not needed. If the computer does not use a land-based connection, a GPS receiver may be needed or a wireless network locating service may use signal strength triangulation to ascertain the location of the recipient.

In any event, to ensure that only the addressed recipient is able to retrieve the message, the sender may set the range to zero or to a few meters or feet (this may be a default setting). Thus, unless the recipient is very near or at the GPS location to which the message is sent, the message may not be retrievable. Alternatively and/or in conjunction with the physical location of the recipient, a password or equivalent security measure may be used. Note that the clearinghouses may have to access a mapping algorithm to convert each street address to its corresponding GPS coordinates to ascertain the physical location of the recipient.

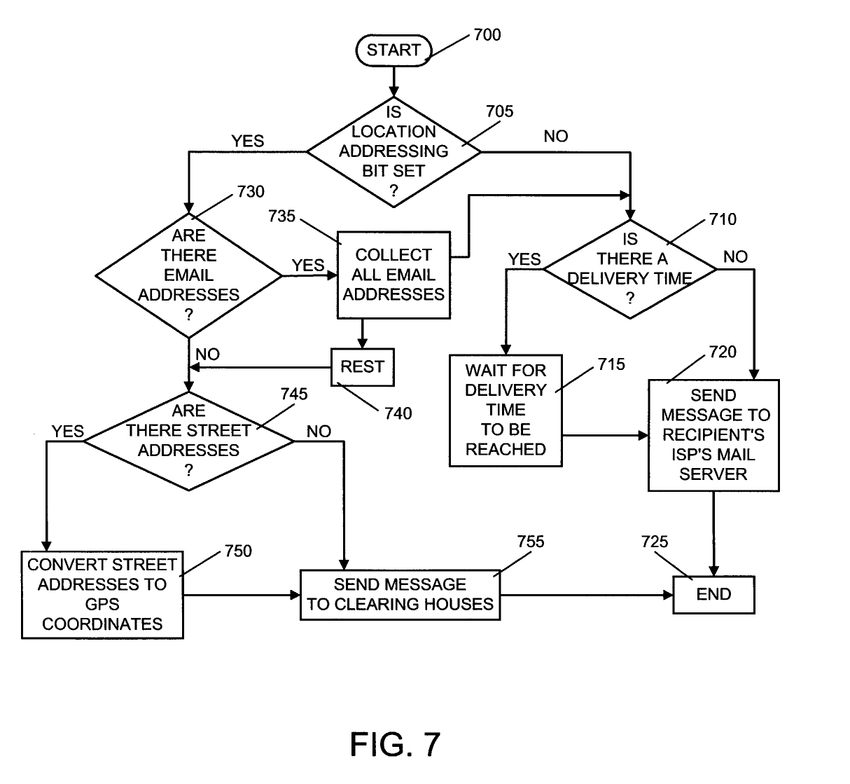

FIG. 6 is a flow chart of a process that may be used by an e-mail software tool to send an e-mail message to a recipient. The process starts when the e-mail software tool is activated (step 600). A determination is made as to whether the location addressing box 425 (FIG. 4) is checked. If it is not checked and there is at least one recipient that is addressed by using either a street address or a physical location, an error is generated instructing the sender that the location addressing box has to be checked first before the e-mail message is transmitted to the mail server of the sender's ISP (steps 605-620). If no recipients are addressed using a street address or a physical location, the message is transferred to the mail server of the sender's ISP (steps 605, 625 and 620).

If the location addressing box 425 is checked, another determination is made as to whether there are any recipients addressed using an e-mail address (steps 605 and 630). If so, the street addresses are first converted to GPS coordinates (if the e-mail software tool used by the sender is capable of doing so). Otherwise, the message is sent to the mail server of the sender's ISP (steps 635, 625 and 620).

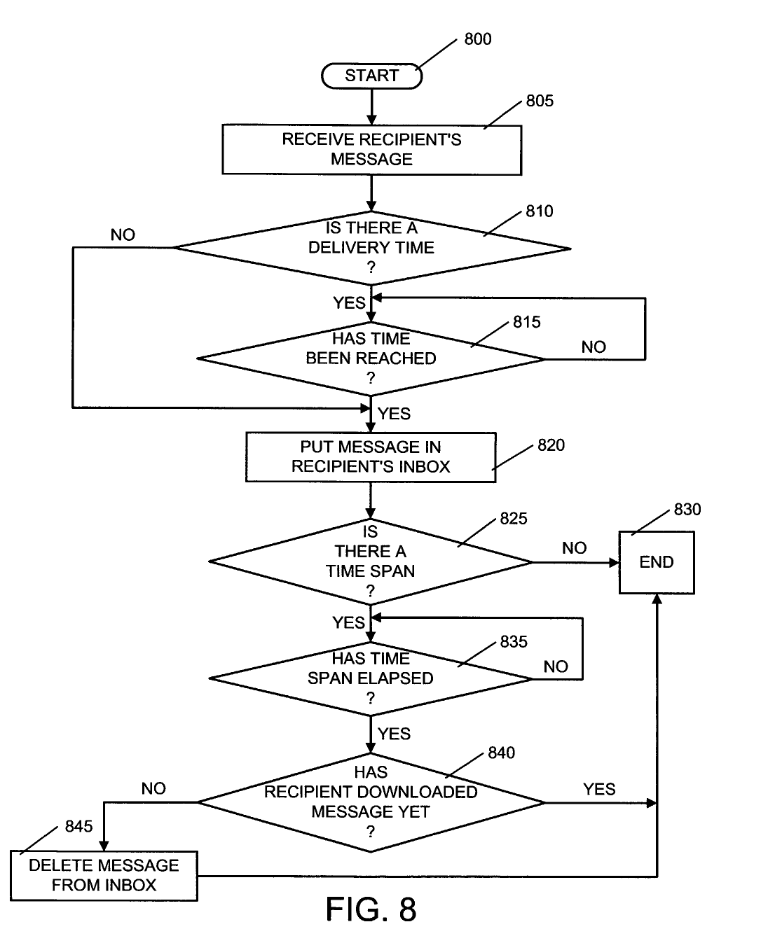

FIG. 7 is a flow chart of a process that may be used by an e-mail software tool of an ISP for implementing the invention. The process starts when the e-mail software tool is activated (step 700). When the mail server receives an e-mail message to be sent to one or more recipients, a determination is made as to whether the location addressing box 425 is checked. If not, another determination is made as to whether there is a delivery time specified. If so, then the message is transferred to the mail servers of the recipients' ISPs at the delivery time specified (steps 705, 710, 715, 720 and 725). If there is not a delivery time specified, it simply transfers the message to the mail servers of the recipients' ISPs (steps 705, 710, 720 and 725).

If the location addressing box 425 is checked, a determination is then made as to whether there are any recipients addressed using a conventional e-mail address. If so, it collects all the e-mail addresses and sends them to the mail servers of the recipients' ISPs following steps 710-725 (see steps 705, 730 and 735). If there is not any recipient addressed using a conventional e-mail address or what is left after collecting all the e-mail addresses goes through the following steps: (1) the message is sent straight to a clearinghouse or clearinghouses if a physical location is used to address the recipients or (2) street addresses are converted to physical locations (e.g., GPS coordinates) before being sent to the clearinghouse or clearinghouses (steps (730-755 and 725).

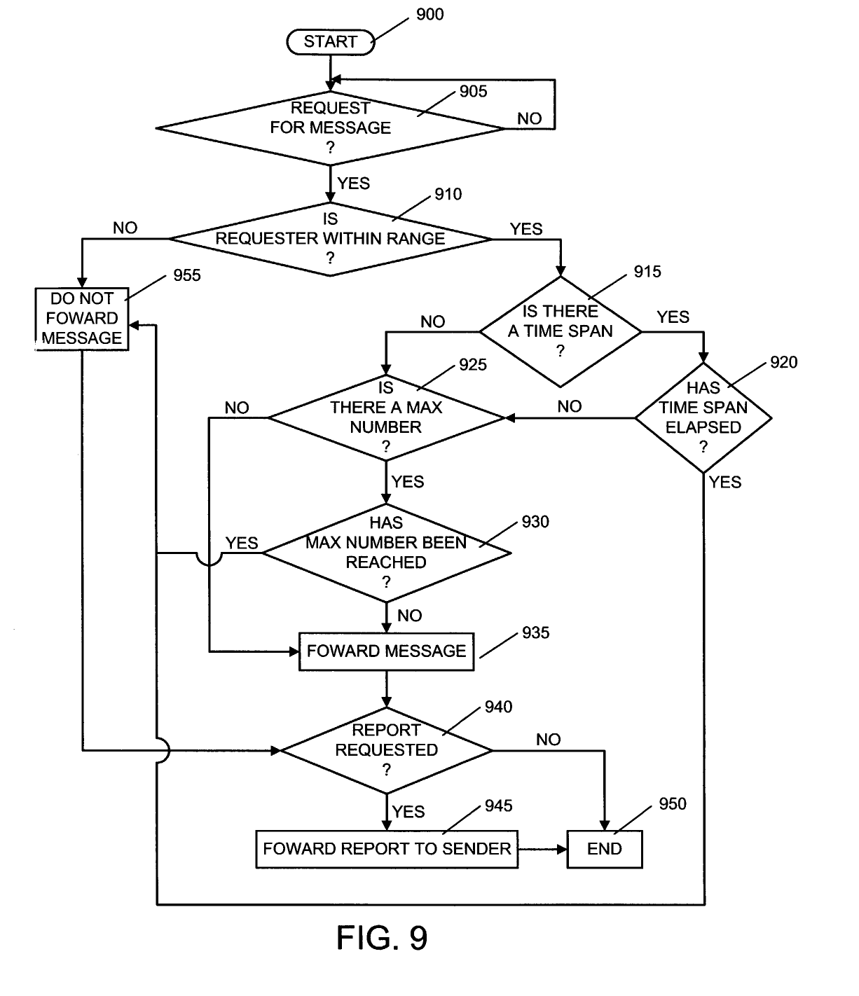

FIG. 8 is a flow chart of a process that may be used by an e-mail software tool of an ISP serving a recipient. The process starts when the e-mail software tool is activated (step 800). When the mail server receives an e-mail message to be delivered to a recipient, a determination is made as to whether there is a delivery time. If not, it simply puts the message in the recipient's inbox in order for the recipient to download the message. If there is a delivery time, it waits until the delivery time is reached before placing the message in the recipient's inbox (steps 805-820). If the message has a time span outside of which the message is not to be delivered, the message will be monitored to see whether or not the time span has elapsed. If the recipient has not downloaded the message within the time span, the message will be deleted from the recipient's inbox (steps 825-845).

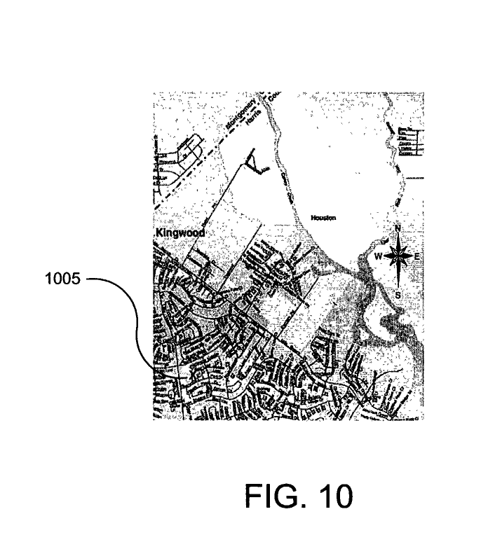

FIG. 9 is a flow chart of a process that may be used by an e-mail software tool of a clearinghouse. The process starts when the e-mail software tool is activated (step 900). When a clearinghouse receives a request for a message, a determination is made as to whether the requester is within the range specified. If so, it determines whether there is a time span associated with the message. If there is a time span and the time span has not yet elapsed, it determines whether there is a maximum number of recipients who can retrieve the message. If the maximum number of recipients has not been reached yet, it forwards the message to the requester. If there is not a time span and the maximum number of recipients who can retrieve the message has not yet been reached, the message is simply forwarded to the recipient (steps 905-935). If the sender requests a report as to the identity of a recipient the report is then forwarded to the sender (steps 940-950).

If the requester is not within the range specified, if the maximum number of recipients has been reached or if the time span has elapsed, the message will not be forwarded to the requester (steps 910, 920, 930 and 955). Again if the sender requests a report regarding the number of recipients who retrieve the message, or when the last recipient retrieves the message etc., the report will be sent to the sender (steps 940-950). These reports will be sent to the sender after either the time span has elapsed or the maximum number of recipients has been reached.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of sending an e-mail message to a recipient comprising the steps of:
composing the e-mail message;
addressing the recipient using a physical location; and
sending the message.

2. The method of claim 1 wherein the physical location is a street address.

3. The method of claim 2 wherein when a street address is used, it is converted to a physical location before it is sent to the recipient.

4. The method of claim 3 wherein the physical location is a set of Global Positioning System (GPS) coordinates.

5. The method of claim 4 wherein the GPS coordinates are geographical coordinates.

6. The method of claim 5 wherein the GPS coordinates include altitudinal, longitudinal and latitudinal positions.

7. A computer program product on a computer readable medium for sending an e-mail message to a recipient comprising:
code means for composing the e-mail message;
code means for addressing the recipient using a physical location; and
code means for sending the message.

8. The computer program product of claim 7 wherein the physical location is a street address.

9. The computer program product of claim 8 wherein when a street address is used, it is converted to a physical location before it is sent to the recipient.

10. The computer program product of claim 9 wherein the physical location is a set of Global Positioning System (GPS) coordinates.

11. The computer program product of claim 10 wherein the GPS coordinates are geographical coordinates.

12. The computer program product of claim 11 wherein the GPS coordinates include altitudinal, longitudinal and latitudinal positions.

13. An apparatus for sending an e-mail message to a recipient comprising:
means for composing the e-mail message;
means for addressing the recipient using a physical location; and
means for sending the message.

14. The apparatus of claim 13 wherein the physical location is a street address.

15. The apparatus of claim 14 wherein when a street address is used, it is converted to a physical location before it is sent to the recipient.

16. The apparatus of claim 15 wherein the physical location is a set of Global Positioning System (GPS) coordinates.

17. The apparatus of claim 16 wherein the GPS coordinates are geographical coordinates.

18. The apparatus of claim 17 wherein the GPS coordinates include altitudinal, longitudinal and latitudinal positions.

19. A system for sending an e-mail message to a recipient comprising:
at least one storage system for storing code data; and
at least one processor for processing the code data to enable a user to compose the e-mail message, to address the recipient using a physical location, and to send the message.

20. The system of claim 19 wherein the physical location is a street address.

21. The system of claim 20 wherein when a street address is used, it is converted to a physical location before it is sent to the recipient.

22. The system of claim 21 wherein the physical location is a set of Global Positioning System (GPS) coordinates.

23. The system of claim 22 wherein the GPS coordinates are geographical coordinates.

24. The system of claim 23 wherein the GPS coordinates include altitudinal, longitudinal and latitudinal positions.

25. A method of sending an e-mail message comprising the steps of:
composing the e-mail message;
addressing the message using a physical location; and
sending the message.

26. The method of claim 25 wherein the physical location is a set of Global Positioning System (GPS) coordinates.

27. The method of claim 26 wherein the message may be retrieved by a plurality of recipients.

28. The method of claim 27 wherein the plurality of recipients is a pre-determined number specified by a sender of the message.

29. The method of claim 28 wherein each recipient who retrieves the message is identified if requested by the sender.

30. The method of claim 29 wherein the message may be retrieved only within a time span.

31. The method of claim 30 wherein the number of recipients who retrieved the message is reported to the sender if requested.

32. The method of claim 31 wherein the time the last recipient retrieved the message is reported to the sender if requested.

33. A computer program product on a computer readable medium for sending an e-mail message comprising:
code means for composing the e-mail message;
code means for addressing the message using a physical location; and
code means for sending the message.

34. The computer program product of claim 33 wherein the physical location is a set of Global Positioning System (GPS) coordinates.

35. The computer program product of claim 34 wherein the message may be retrieved by a plurality of recipients.

36. The computer program product of claim 37 wherein the plurality of recipients is a pre-determined number specified by a sender of the message.

37. The computer program product of claim 36 wherein each recipient who retrieves the message is identified if requested by the sender.

38. The computer program product of claim 37 wherein the message may be retrieved only within a time span.

39. The computer program product of claim 38 wherein the number of recipients who retrieved the message is reported to the sender if requested.

40. The computer program product of claim 39 wherein the time the last recipient retrieved the message is reported to the sender if requested.

41. An apparatus for sending an e-mail message comprising:
means for composing the e-mail message;
means for addressing the message using a physical location; and
means for sending the message.

42. The apparatus of claim 41 wherein the physical location is a set of Global Positioning System (GPS) coordinates.

43. The apparatus of claim 42 wherein the message may be retrieved by a plurality of recipients.

44. The apparatus of claim 43 wherein the plurality of recipients is a pre-determined number specified by a sender of the message.

45. The apparatus of claim 44 wherein each recipient who retrieves the message is identified if requested by the sender.

46. The apparatus of claim 45 wherein the message may be retrieved only within a time span.

47. The apparatus of claim 46 wherein the number of recipients who retrieved the message is reported to the sender if requested.

48. The apparatus of claim 47 wherein the time the last recipient retrieved the message is reported to the sender if requested.

49. A system for sending an e-mail message comprising:
at least one storage system for storing code data; and
at least one processor for processing the code data to enable a user to compose the e-mail message, to address the message using a physical location, and to send the message.

50. The system of claim 49 wherein the physical location is a set of Global Positioning System (GPS) coordinates.

51. The system of claim 50 wherein the message may be retrieved by a plurality of recipients.

52. The system of claim 51 wherein the plurality of recipients is a pre-determined number specified by the user.

53. The system of claim 52 wherein each recipient who retrieves the message is identified if requested by the user.

54. The system of claim 53 wherein the message may be retrieved only within a time span.

55. The system of claim 54 wherein the number of recipients who retrieved the message is reported to the user if requested.

56. The system of claim 55 wherein the time the last recipient retrieved the message is reported to the user if requested.
